(19) United States
(12) Patent Application Publication
(10) Pub. No.: US 2009/0050000 A1
(43) Pub. Date: Feb. 26, 2009

(54) BIOMASS PRESSURE LIQUID RECOVERY SYSTEM

(76) Inventor: Norman Murray Stephens, Abbotsford (CA)

Correspondence Address: ADE & COMPANY INC., 2157 Henderson Highway, WINNIPEG, MB, R2G1P9, CA

(21) Appl. No.: 12/202,567

(22) Filed: Sep. 2, 2008

(30) Foreign Application Priority Data
Feb. 2, 1994 (GB) 2269131

(51) Int. Cl. B30B 9/16

(52) U.S. Cl. 100/37; 100/110

(57) ABSTRACT

An apparatus for extracting liquid from a biomass material for removal or recovery by compaction uses an auger with multiple flights within a barrel to compress the biomass material such as straw, sawdust, or flax waste which can contain up to 50% liquid content through a discharge end of the barrel. The material is forced by inclined tips on the end of the auger flights into a polygonal forming barrel which includes a slotted section such that the liquid content is released from the material under the high temperature and pressure generated by the auger through the slots. This way, the machine uses the same mechanical process to both compact and dry out the biomass material, thereby reducing or eliminating the need to dry the biomass material in a separate prior process.

This invention relates to an apparatus and method for extracting liquid from a biomass material for removal or recovery by compaction.

### BACKGROUND OF THE INVENTION

US Patent Application 2008/0057282 (Bishop) published Mar. 6, 2008 discloses a portable biomass densifier including an auger or screw that conveys biomass material fed into a cylinder of the auger from a tapered hopper above the cylinder. The auger forces the material toward a vented barrel and compresses the material into the barrel. The vented barrel has a plurality of elongated openings or slots therein, so that as the material is fed into the barrel and is further compressed, the heat and pressure of the extruder releases gasses from the biomass material through the slots in the barrel without requiring a separate heat source. The compressed material can be used as a combustion product.

UK Patent Application 2,269,131 (Clifton) published Feb. 2, 1994 discloses a very similar arrangement.

### SUMMARY OF THE INVENTION

It is one object of the invention to provide an apparatus for extracting liquid from a biomass material for removal or recovery by compaction.

According to one aspect of the invention there is provided an apparatus for extracting liquid from a biomass material for removal or recovery by compaction comprising:

a generally cylindrical compression barrel having a discharge opening at one end of the compression barrel, a lead end opposite the discharge end and a peripheral wall;

a feed inlet opening in the peripheral wall of the compression barrel through which the biomass material is fed in use;

a feed hopper for feeding the biomass material into the feed inlet opening;

an auger shaft extending through the lead end of the compression barrel and extending coaxially along the compression barrel to the discharge end such that rotation of the auger shaft within the compression barrel acts to carry the biomass materials from the feed inlet opening to the discharge end and to apply pressure to the biomass material as it is discharged through the discharge end;

and a forming barrel mounted at the discharge end of the compression barrel and arranged to receive the biomass material therefrom, the barrel having a series of longitudinally extending slots allowing the escape of liquid content from the compressed material.

Preferably the auger shaft carries a plurality of helical flights which is preferably at least three, each having start and end positions of the flight longitudinally spaced from the start and end of the other flight or flights and with the flights having outer edges at the peripheral wall of the compression barrel.

Preferably the shaft comprises a sleeve carrying the auger flight and inner shaft with a shear pin connecting the sleeve to the inner shaft.

Preferably the forming barrel has an outer wall which is connected at the discharge end and has a transverse dimension greater than that of the compression barrel such that it is spaced outwardly of an imaginary cylinder defined by the peripheral wall.

Preferably the auger shaft has an end portion which projects partly into the forming barrel so that the plurality of helical flights each have an end portion which projects into the forming barrel.

Preferably each of the flights has a tip portion thereon which is rotated around the shaft axis with the flight, where the end tip portion is inclined so that it has an angularly leading edge and an angularly trailing edge where the trailing edge is located at an axially advanced position so as to pass over the laid down material in the forming barrel in a wiping action.

Preferably the forming barrel has a peripheral wall at least a part of which and preferably substantially all of which is formed from a series of parallel longitudinally extending bars defining slots therebetween with the bars being supported by a series of longitudinally spaced, peripherally extending ribs to hold them against outward movement under the pressure from the compressed biomass material.

Preferably the spacing between the bars is of the order of or less than 0.030 inch. Such material is commercially available and is known as “wedge wire”.

Preferably there is provided a collection container surrounding the forming barrel for collecting liquid and gases escaping from the forming barrel. This may act to condense any vapor and to collect any liquid to prevent the escape into the atmosphere and to collect the material if it has a value.

Preferably the peripheral wall of the forming barrel is defined by a plurality of planar wall portions so as to be polygonal with each of the planar wall portions being formed from the parallel bars defining slots therebetween.

Preferably the forming barrel includes dividing walls extending longitudinally and transversely of the barrel for dividing the forming barrel and the biomass material therein into separate portions.

Preferably the feed hopper is arranged to one side of the compression barrel so as to feed into the side of the barrel.

Preferably the feed hopper includes an auger along a bottom of the hopper and a pair of rotating bars each extending along the hopper on a respective side of the auger and parallel to the auger and each having a plurality of outwardly extending members for breaking bridging of the biomass material in the hopper.

Preferably the feed hopper includes an auger and at least one rotating member for breaking bridging of the biomass material in the hopper.

Preferably there is provided an end plate on the end of the forming chamber with an adjustable orifice which partly closes a discharge end of the forming barrel to provide a back pressure on the biomass material in the forming barrel.

According to a second aspect of the invention there is provided a method for extracting liquid from a biomass material for removal or recovery by compaction comprising:

providing a generally cylindrical compression barrel having a discharge opening at one end of the compression barrel, a lead end opposite the discharge end and a peripheral wall;

feeding the biomass material into a feed inlet opening in the peripheral wall of the compression barrel;

rotating an auger shaft within the compression barrel acts to carry the biomass materials from the feed inlet opening to the discharge end and to apply pressure to the biomass material as it is discharged through the discharge end;

the auger shaft driving the biomass material from the compression barrel into the forming barrel mounted at the discharge end of the compression barrel;

the forming barrel having a peripheral wall at least a part of which is formed from a series of parallel longitudinally extending bars defining slots therebetween with the bars being supported to hold them against outward movement under the pressure from the compressed biomass material;

the biomass material containing a liquid content between 10% and 50%;

and generating sufficient heat and pressure in the forming barrel to cause at least part of the liquid content to be discharged through said at least a part of the peripheral wall.

Preferably the pressure generated in the forming chamber is at least 1000 psi and is more preferably of the order of 20,000 psi.

Preferably the density of the compressed biomass material discharged from the forming barrel is of the order of 50 lbs/cu ft.

The arrangement therefore provides a biomass compactor using an auger to compress the biomass material such as straw, sawdust, or flax waste which can contain high levels of liquid up to 50%. The compactor has a slotted section formed by the bars closing around the materials path through the machine such that moisture released from the material under the high temperature and pressure generated by the auger can be released through the slots. This way, the machine uses the same mechanical process to both compact and dry out the biomass material, thereby reducing or eliminating the need to dry the biomass material in a separate prior process.

### BRIEF DESCRIPTION OF THE DRAWINGS

One embodiment of the invention will now be described in conjunction with the accompanying drawings in which:

FIG. 1 is a schematic side elevational view of a biomass compactor according to the present invention.

FIG. 2 is a schematic top plan view of the biomass compactor of FIG. 1.

FIG. 3 is an end elevational view of the forming barrel taken along the lines 3-3 of the biomass compactor of FIG. 1.

In the drawings like characters of reference indicate corresponding parts in the different figures.

### DETAILED DESCRIPTION

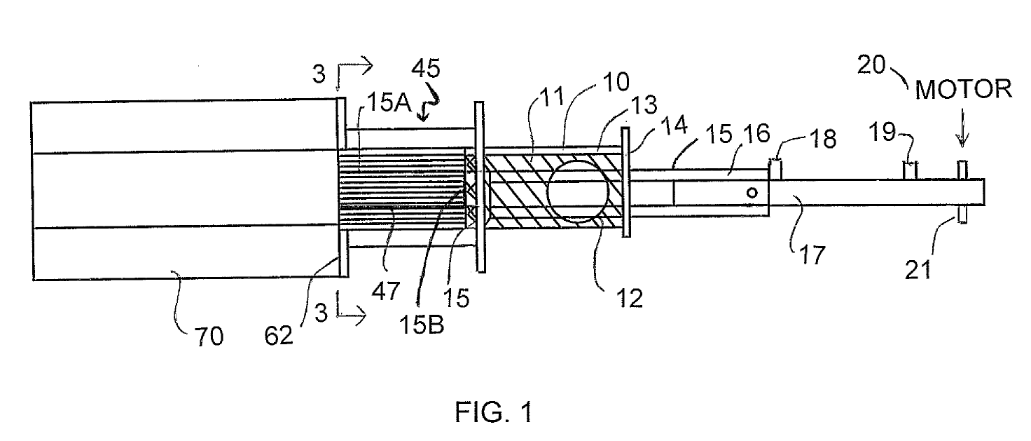

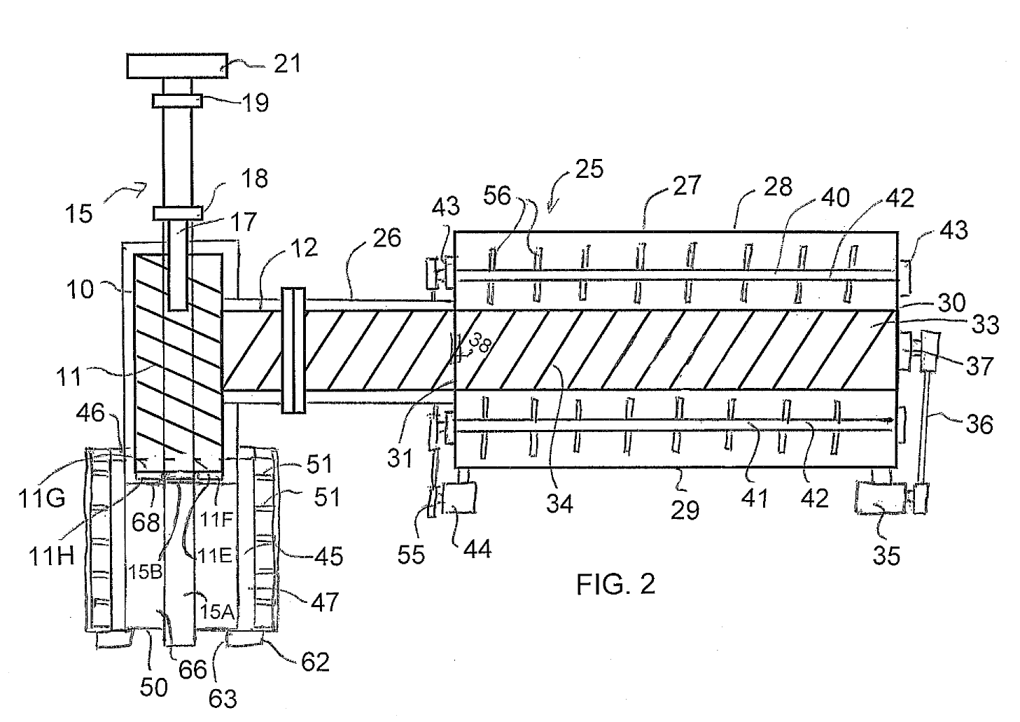

In FIGS. 1 and 2 is shown generally the biomass compactor which includes a primary cylinder or barrel 10 which acts as a compression barrel within which the biomass material is compressed by an auger 11 within the barrel 10. The barrel 10 has an inlet 12 in one side. Barrel 12 has a cylindrical peripheral wall 13, a first closed end 14 and a second open end 15 through which the compressed materials are discharged.

The auger 11 comprises a series of independent flights so that each flight has a start position and an end position where the ends of the flights are spaced longitudinally along the auger shaft. This forms a multi-start auger system in which the material entering the barrel can engage into the position between the individual flights to be carried by the flights during their movement caused by rotation of the auger shaft 15. The auger shaft 15 is formed from a sleeve 16 and an inner shaft 17 on which the sleeve 16 is mounted. The shaft 17 is carried in bearings 18 and 19 and is driven by a motor 20 communicating drive to an input pulley 21. Thus the shaft extends coaxially with the cylinder 10 and the sleeve 16 is carried on the outside surface of the shaft 17 so that the sleeve and the shaft project into the interior of the barrel and axially along the barrel 10 to the discharge end 15. The auger flights are mounted on the outside of the sleeve 16 and extend from the outside surface of the sleeve 16 to the cylindrical inside surface of the barrel 10. This provides a spacing between the outside surface of the sleeve and the inside surface of the barrel 10 which is of the order of 2 inches in height. Typically the sleeve has an outside diameter of the order of 4 inches so that the inside of the barrel has a diameter of the order of 8 inches. These dimensions are of course only typical and other dimensions can be used particularly when the structure is scaled upwardly to larger dimensions for transporting and compressing larger quantities of material.

The inlet 12 of the barrel 10 is supplied by a feed system generally indicated at 25 which includes a tube 26 which is fed from a hopper 27. The tube 26 extends horizontally away from one side of the barrel 10 and the hopper 27 is mounted on an outer end of the tube so as to provide feed material to be fed into the tube and along the tube into the inlet 12. The hopper 27 is generally rectangular with side walls 28 and 29 and end walls 30 and 31 with the end walls at right angles to the tube 26. At the bottom, the hopper converges inwardly to a base 33 centrally of the side walls 28 and 29 and generally aligned with the tube 26. An auger 34 is mounted at the base so that the materials falling to the base and converge inwardly to the base are carried along the base and into the tube 26 by the auger 34 and the flights thereon. The auger 34 is driven by a motor 35 through a drive chain 36 at the end 30 of the hopper. The auger 34 is mounted in bearings 37 and 38 at the end walls 30 and 31 and extends up to the entrance into the barrel 10 so as to compress the materials from the hopper and feed the materials into the auger flights to ensure a smooth continuous flow of the material into the auger flights on the shaft 15.

As many of the materials to be supplied into the barrel 10 for compression are fibrous, bridging is typically a problem within the hopper so that rotating members 40 and 41 are provided within the hopper above the auger 34 and on opposite sides of the auger 34. The rotating members 40 and 41 comprise shafts 42 carried in bearings 43 and driven by a motor 44 through a chain drive system 55. The rotary members 42 carry fingers or blades 56 projecting outwardly from the bars 42 for engaging into the material.

Typically the auger 34 rotates at an angular rate which is variable to control an input speed whereas the rotating members 40 and 41 which are not intended to carry out any driving action rotate at a slow rate at the order of 5 to 10 RPM.

The auger 11 carried on the shaft 15 carries, as previously explained, a plurality of auger flights. In the embodiments shown there are four such auger flights indicated at 11A, 11B, 11C and 11D. Each of these auger flights extends to an end 11E at the discharge from the barrel 10. Each of these auger flights has attached thereto a tip portion 11F at or adjacent the end 11E. This tip portion is formed of a wear resistant material such as carbide. As shown in FIG. 2, the ends 11E and the tip portions 11F project into a forming barrel 45 so that they project beyond an end wall 46 of the barrel 10 and thus provide a short portion which is proud of the end wall 46 and projects into the interior of the forming barrel 45.

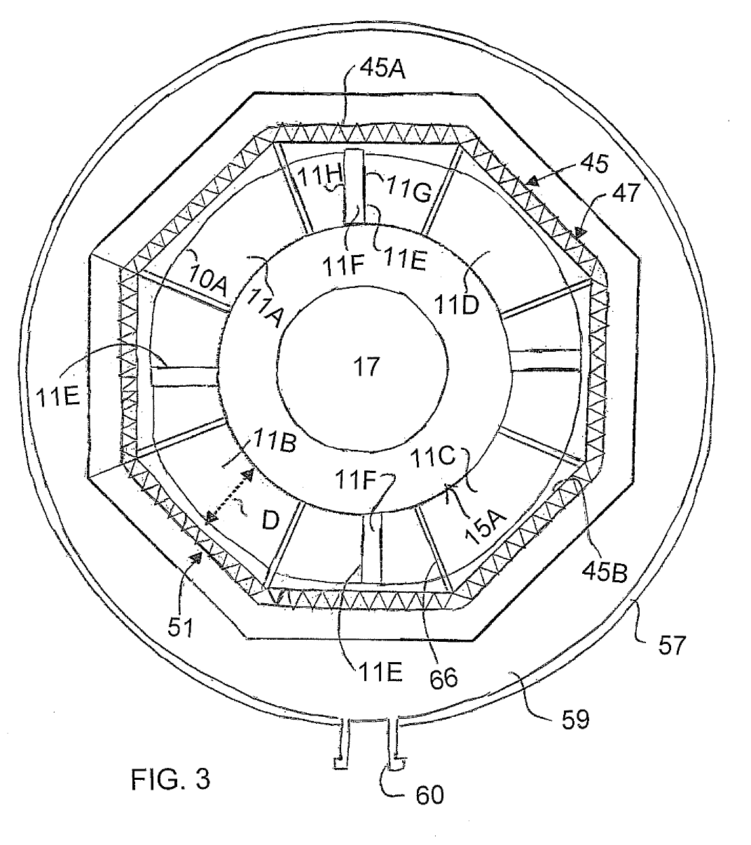

Each of the tips 11F has a leading end 11G and a trailing end 11H. The tips are mounted on the auger flights so that the leading ends 11G all lie substantially in a common plane radial to the axis of the shaft 15. Thus the leading edges of the tips in the clockwise direction of rotation of the auger 11 as shown in FIG. 3 lie in a first plane radial to the axis of the shaft and the trailing edges 11H all lie in a second plane at radial of the axis. The second plane radial of the axis of the edges 11H is arranged to be axially advanced further into the forming barrel than the leading edges. In this way the tips form wiping blades which wipe over the material sitting in the barrel 45 so as to push against the rear surface of that material in a wiping action to smooth the material and to apply compressive force against the material to force the material along the barrel 45.

Thus as the auger 11 rotates, each flight carries material forwardly and discharges it into the barrel 45. That material as it is discharged is then wiped and smoothed by the action of the tips. This arrangement has been found to provide an effective action in compressing and squeezing the materials to apply high compressive forces which also significantly increase the temperature within the material at this location.

The effect of the multi-start auger together with the tips can apply a pressure up to 20,000 psi within the material at the entrance to the forming barrel 45. At the same time the temperature is typically elevated to a temperature of the order of 400° F. This high compression and high temperature acts to evaporate liquids and moisture within the material so that the gases so formed are driven off from the material.

As best shown in FIG. 3, the barrel 10 has a circular opening 10A at the discharge end which emerges into the barrel 45. The barrel 45 is of increased transverse dimension so that a space is formed between the imaginary cylinder defined by the outside edge of the opening 10A and the inside surface 45B of the barrel 45. Thus the material which is fed forwardly by the auger 11 on the shaft 15 emerges through the annular space around the shaft 15 and inside the opening 10A of the barrel 10 and that material is forced axially as well as outwardly into the space inside of the wall of the barrel 45. The area beyond the end of the shaft 15 is filled by a shaft extension portion 15A which is coaxial with the shaft 15 and of the same diameter and extends into the barrel 45 along its full length. The extension portion 15A is stationary and has an end 15B butting against the end of the shaft 15 at the end of the auger at the location just inside the barrel 45.

The previously explained wiping action carried out by the tips 11F acts to apply pressure onto the material forcing it into a generally cylindrical area beyond the annular space and outwardly of the annular space to fill the whole of the interior of the barrel 45 outside the extension portion 15A.

This generates a compressed mass which is generally cylindrical with an inner surface defined by the outer surface of the cylindrical extension portion 15A.

Thus the mass formed in the compression is cylindrical with a distance D from the inside surface to the wall of the barrel 45 which is of the order of 2.0 inches. In this way the distance of any point in the compressed mass to the slotted wall of the barrel is relatively small and generally less than 3.0 inches so that gases and vapour and liquid can readily escape under compression.

The barrel 45 is polygonal in shape formed by wall portions 45A. In the example shown the barrel is octagonal with the wall portions of equal width. However other shapes can be used including square barrels and irregular shaped polygonal barrels.

The wall portions 45A are each defined by a series of parallel longitudinally extending bars 47 which lie in a common plane of the wall portion 46. The bars are supplied with a support system which holds the bars at a pre determined spacing which is typically of the order of 0.030 inch. The bars are triangular in shape with a flat face facing inwardly and an apex facing outwardly to provide sufficient strength for the bar while allowing a narrow slot at the face of the wall which faces inwardly.

Such structures are commonly available and are widely used in the oil industry under the trade name “Wedge-Wire”. Such materials are supplied with the ability to withstand significant outward forces while maintaining the narrow gap between each bar and the next bar. The bars extend along the full length of the chamber 45 from the end wall 46 through to a discharge end 50 of the forming chamber. The bars are supported by peripheral ribs 51 which are located at spaced positions along the length of the bar. Each rib 51 forms a peripheral flange extending around the full periphery of the barrel 45 so as to provide a fully surrounding band which prevents the significant forces within the barrel 45 from bowing the bars 47 outwardly.

The ribs 51 are continuous around the bars 47 so that outward stresses from the bars are communicated into tension in the ribs. An inside edge of the ribs engages the outside tip of the bars 47 to hold the tips against outward movement. The ribs can are welded at spaced positions along the bars.

The ribs are formed from sheet metal with the inside edge in contact with the bars and an outside edge spaced outwardly therefrom. In this way the ribs interfere with the exit of gases and liquid to the minimum extent.

Around the forming barrel 45 is provided a collection chamber 57 which is formed from a peripheral wall 58 and end walls 59 which contain the whole of the forming barrel such that the gases and liquid escaping are contained within the outside container 57 and can drain to a discharge opening 60 for collection. A vacuum can be applied at the discharge 60 to draw off the gases so that they can discharged safely or can be collected if valuable. In this way oils and other valuables excreted from the compressed materials can be collected for processing and sale. In this way the environment within the area surrounding the device can be kept free from contaminants exiting from the forming barrel.

An end plate 62 is provided on the end of the forming barrel and provides an orifice 63 through which the materials are discharged. The end plate 62 can be adjusted so as to change the dimensions of the orifice so that the plate provides a back pressure on the materials being forced through the forming barrel. This is particularly desirable at start-up in order to commence the application of back pressure through the forming barrel and into the compression barrel. Once the back pressure is developed, the friction between the materials and the wall of the forming barrel maintain that back pressure at a required level so as to generate the required pressures within the material.

Typically the shaft can be driven at a rate in the range 50 to 400 RPM depending on size. This rate can of course be varied within this range to control the pressures within the system. Other parameters can be varied to control the conditions within the system.

Typically the machine can be controlled so as to generate pressures in the range 1000 TO 20,000 psi and temperatures in the range 250 to 450 degrees F. Control of the system is primarily managed by measuring the temperature by a suitable sensor at the main compaction area at the tips of the auger and by measuring pressure within the compaction zone obtained by maintaining a resultant density in the range 50 to 65 lbs/cu ft.

In order to provide a sufficient throughput of material, the space between the extension portion 15A and the wall of forming barrel 45 is generally of the order of 2 to 3 inches in transverse dimension. However this total area of the cylindrical shape is too great in most cases to form an acceptable product which can be used in subsequent combustion processes. In order to manufacture combustion products of a desired transverse dimension, divider walls 66 are provided within the forming barrel which divides the total area into smaller separate areas with the materials being separated at a leading edge 68 of the dividing walls. This leading edge is located immediately downstream of the trailing edge 11H of the tips of the auger. The dividing walls are formed of sheet metal so as to reduce friction and allow the compressed materials to slide along the surfaces of the dividing walls and along the surfaces of the bars 47.

In FIG. 1 is shown an additional component 70 which is mounted beyond the exit gate 62 defined by the plate and this component forms a long tube through which the materials emerge so as to provide a cooling action. The structure can be formed of aluminium to ensure the extraction of significant quantities of heat so that the emerging compressed materials are sufficiently cooled for handling.

As an alternative, the forming barrel defined by the bars 47 can be removed from the end wall of the compression barrel and replaced by a simple tubular forming member defined by the component 70. The forming barrel 45 can be removed and replaced by a forming barrel defined by the component 70 in the event that the materials are sufficiently dry and free from oil to remove the necessity for extraction of such materials through the bars 47. However the forming barrel used has basically the same arrangements and characteristics as that previously described except that it is formed from the same tubular structure. Thus it co-operates with the tips of the auger as previously described and thus it includes dividing walls as previously described. In this case the forming barrel defined by the component 70 is longer since it carries out both the functions of forming and of cooling.

The apparatus uses primarily stainless steel components due to the high acid content of many of the biomass feed stock materials it can be used to de-water.

Animal wastes, oil seed plant wastes and other biomass feed stock with moisture contents up to 50% can be reduced to solids exhibiting very low moisture content. In order to achieve this, the pressure within the entrance to the forming barrel is typically of the order of 20,000 PSI. The resulted solids are appropriate for burning in a down draft gasifier or other conventional combustion system and typically such systems require a density of the compressed product of the order of 50 lbs. per cubic foot.

As shown the construction uses four auger flights and therefore includes four tips. However this may be reduced to three or increased as required. The use of multiple tips in this manner permits faster throughput while minimizing side thrust. As the flights are spaced around the axis, this spreads the side to side forces generated by the forwarding of the material around the axis.

The auger produces a hollow cylindrical compacted shape permitting liquid to leave the biomass compressed product at a very high rate. This produces a large volume of dewater material with reduced energy costs. Liquid, air and steam in the feedstock will migrate the short distance from the outside edge of the auger at the tips 11F and from the outside of the extension portion 15A to the slots between the bars where it is released. It will be appreciated that the significant point of compression and heating occurs at the tips of the auger flights where the material is pushed into and applied onto existing material within the forming barrel. At this location, therefore, the maximum heating action occurs as the compression effect is maximized.

Typical materials which can be processed include animal waste including poultry, cow and hog manure and even including sewage waste from households. The liquid extracted can be used as fertilizer. The solids material in the compacted shapes can be used as a combustion fuel.

The temperature of compression which generally reaches of the order of 400 degrees F. acts to sterilize pathogens.

Other materials can be processed including various plant products. One process includes growing hemp and similar plants on contaminated land which act to draw out the contaminants, following which the plant material is compressed in the system described above to extract oil while the contaminants remain in the compacted solids and can be extracted by combustion while using the heat generated. Such contaminants can include various metals which can be extracted and valuable metals collected.

Another process involves waste paper where the compaction can be used to extract the liquid content including ink, the compacted solids formed into a fuel product which is used in a combustion system and remaining clay from the paper being collected in the ash. Thus all of the components of the waste paper are either recovered or used to generate heat as a fuel.

These processes are enabled by the high level of liquid content which is allowed in the system and by the efficient use of energy to drive the system to effect the compaction.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for extracting liquid from a biomass material for removal or recovery by compaction comprising:
a generally cylindrical compression barrel having a discharge opening at one end of the compression barrel, a lead end opposite the discharge end and a peripheral wall;
a feed inlet opening in the peripheral wall of the compression barrel through which the biomass material is fed in use;
a feed hopper for feeding the biomass material into the feed inlet opening;
an auger shaft extending through the lead end of the compression barrel and extending coaxially along the compression barrel to the discharge end such that rotation of the auger shaft within the compression barrel acts to carry the biomass materials from the feed inlet opening to the discharge end and to apply pressure to the biomass material as it is discharged through the discharge end;
and a forming barrel mounted at the discharge end of the compression barrel and arranged to receive the biomass material therefrom, the barrel having a series of longitudinally extending slots allowing the escape of liquid content from the compressed material.

2. The apparatus according to claim 1 wherein the auger shaft carries a plurality of helical flights each having start and end positions of the flight longitudinally spaced from the start and end of the other flight or flights.

3. The apparatus according to claim 2 wherein there are three flights.

4. The apparatus according to claim 1 wherein the flights have outer edges at the peripheral wall of the compression barrel.

5. The apparatus according to claim 1 wherein the shaft comprises a sleeve carrying the auger flight and inner shaft with a shear pin connecting the sleeve to the inner shaft.

6. The apparatus according to claim 1 wherein the forming barrel has an outer wall which is connected at the discharge end and has a transverse dimension such that it is spaced outwardly of an imaginary cylinder defined by the peripheral wall.

7. The apparatus according to claim 1 wherein the auger shaft has an end portion which projects partly into the forming barrel.

8. The apparatus according to claim 1 wherein the auger shaft carries a plurality of helical flights each having start and end positions of the flight longitudinally spaced from the start and end of the other flight or flights and wherein each of the flights has an end portion which projects into the forming barrel.

9. The apparatus according to claim 1 wherein each of the flights has a tip portion thereon which is rotated around the shaft axis with the flight, where the end tip portion has an angularly leading edge and an angularly trailing edge where the trailing edge is located at an axially advanced position.

10. The apparatus according to claim 1 wherein the auger shaft carries at least one end tip portion thereon which is rotated around the shaft axis where the end tip portion has an angularly leading edge and an angularly trailing edge where the trailing edge is located at an axially advanced position.

11. The apparatus according to claim 1 wherein the forming barrel has a peripheral wall at least a part of which is formed from a series of parallel longitudinally extending bars defining slots therebetween with the bars being supported to hold them against outward movement under the pressure from the compressed biomass material.

12. The apparatus according to claim 1 wherein the forming barrel has a peripheral wall which is substantially wholly formed from a series of parallel longitudinally extending bars defining slots therebetween with the bars being supported to hold them against outward movement under the pressure from the compressed biomass material.

13. The apparatus according to claim 12 wherein the bars are supported by a series of longitudinally spaced, peripherally extending ribs.

14. The apparatus according to claim 12 wherein the spacing between the bars is of the order of 0.030 inch.

15. The apparatus according to claim 1 wherein there is provided a collection container surrounding the forming barrel for collecting liquid and gases escaping from the forming barrel.

16. The apparatus according to claim 1 wherein there is provided a cylindrical extension portion of the auger shaft along the forming barrel such that the compressed material forms a hollow cylinder.

17. The apparatus according to claim 1 wherein the forming barrel is formed from a series of parallel longitudinally extending bars defining slots therebetween with the bars being supported to hold them against outward movement under the pressure from the compressed biomass material.

18. The apparatus according to claim 1 wherein the forming barrel includes dividing walls extending longitudinally and transversely of the barrel for dividing the forming barrel and the biomass material therein into separate portions.

19. The apparatus according to claim 1 wherein the feed hopper is arranged to one side of the compression barrel so as to feed into the side of the barrel.

20. The apparatus according to claim 19 wherein the feed hopper includes an auger along a bottom of the hopper and a pair of rotating bars each extending along the hopper on a respective side of the auger and parallel to the auger and each having a plurality of outwardly extending members for breaking bridging of the biomass material in the hopper.

21. The apparatus according to claim 1 wherein the feed hopper includes an auger and at least one rotating member for breaking bridging of the biomass material in the hopper.

22. The apparatus according to claim 1 wherein there is provided an end plate on the end of the forming chamber with an adjustable orifice which partly closes a discharge end of the forming barrel to provide a back pressure on the biomass material in the forming barrel.

23. A method for extracting liquid from a biomass material for removal or recovery by compaction comprising:
providing a generally cylindrical compression barrel having a discharge opening at one end of the compression barrel, a lead end opposite the discharge end and a peripheral wall;
feeding the biomass material into a feed inlet opening in the peripheral wall of the compression barrel;
rotating an auger shaft within the compression barrel acts to carry the biomass materials from the feed inlet opening to the discharge end and to apply pressure to the biomass material as it is discharged through the discharge end;
the auger shaft driving the biomass material from the compression barrel into the forming barrel mounted at the discharge end of the compression barrel;
the forming barrel having a peripheral wall at least a part of which is formed from a series of parallel longitudinally extending bars defining slots therebetween with the bars being supported to hold them against outward movement under the pressure from the compressed biomass material;
the biomass material containing a liquid content between 10% and 50%;
and generating sufficient heat and pressure in the forming barrel to cause at least part of the liquid content to be discharged through said at least a part of the peripheral wall.

24. The method according to claim 23 wherein the pressure generated in the forming chamber is at least 20,000 psi.

25. The method according to claim 23 wherein there is provided a cylindrical portion along the forming barrel such that the compressed material forms around the cylindrical portion a hollow cylinder.
